(19) United States
(12) Patent Application Publication
(10) Pub. No.: US 2007/0108882 A1
(43) Pub. Date: May 17, 2007

(54) Incandescent lamp including self sealing mount base

(76) Inventors: Jerome J. Schneider JR., Chagrin Falls, OH (US); Bart Terburg, Mayfield Village, OH (US)

Correspondence Address: FAY SHARPE LLP, 1100 SUPERIOR AVENUE, SEVENTH FLOOR, CLEVELAND, OH, 44114, US

(21) Appl. No.: 11/280,663

(22) Filed: Nov. 16, 2005

(51) Int. Cl. H01J 5/48

(52) U.S. Cl. 313/318.01

(57) ABSTRACT

An incandescent light source finds particular use in a lamp having a reflector as provided. The light source comprises an elongated envelope having a major axis and a filament secured therein such that a major axis of the filament is parallel or offset from the major axis of the envelope. A first fin is secured to the elongated envelope which supports the envelope against vibrations. A base is also connected to the light source. The base includes a body, two leads, a flange extending radially from the body, a projection extending axially from the flange, and a twist lock construction capability comprising lugs that defines a fiducial plane for setting the focal point of the incandescent light source. To connect the base to the envelope, the projection is dimensioned to extend through an aperture of the reflector then rotated to engaging the reflector thereby securing the base to the reflector.

### BACKGROUND OF THE INVENTION

The present disclosure relates to an incandescent lamp and more particularly to an incandescent lamp including a self-sealing mounting base. It finds particular application in the automotive industry for use in a fog lamp. However, it is to be appreciated that the present invention is also amenable to other like environments and applications.

A typical fog lamp assembly includes a light source or lamp located at a focus of a reflector so that light emitted from the light source is directed through a lens of the assembly to achieve a predetermined beam pattern. Generally, the lamp assembly uses a halogen light source.

The light source is typically fixed onto a base and mounted to the lamp assembly. The base and the light source mounted thereon form a replaceable bulb. In order for the lamp to be acceptable to the average consumer, it must be cost competitive relative to other similar lamp assemblies and must also be reliable. Therefore the replacement bulb must be of a construction with few parts for ease of assembly, quality and cost reasons. Proper alignment and stability of the light source inside the lamp assembly are important requirements for the performance of the lamp. The light source must be aligned in a specific position with respect to the base. Once aligned and precisely locked in the appropriate position with respect to the base, the bulb must remain in that aligned position during use for acceptable performance of the lamp assembly.

There is a need for increased stability in association with a replacement lamp, as well as providing a twist and lock arrangement that eliminates the need for a retaining ring, in combination with assured optical capabilities. Heretofore, known arrangement have addressed one or the other of these problems. A need exists to provide a replaceable lamp that has superior optical capabilities, OEM quality, and can be economically sealed to a reflector housing.

Generally, a gimbal device is one of the mechanisms used to align the light source with respect to the plastic base. The gimbal, which serves as a holder for the lamp may also be required to insulate the plastic base from the heated bulb. The gimbal is generally contained within a cylindrical opening in the plastic base from which the light source can be aligned, after which the gimbal is attached to the plastic base by either thermal or mechanical means so as to secure the lamp in the aligned position.

While some prior art replaceable lamp designs and constructions are satisfactory, it is desirable to develop continued improvements and alternative designs for replaceable lamps. For example, it would be desirable to simplify assembly and provide a base for reliability in firmly supporting and aligning the light source, without the need for a gimbal. A replaceable lamp without a gimbal enables the possibility to design the lamp with a shorter light-center-length (LCL) and shorter overall length. This enables a fog lamp reflector with shorter focal length. Short focal length fog lamps are preferred for economical reasons as they require less material to fabricate. Shorter focal length fog lamps also meet the need from vehicle manufacturers to have reduced build-in depth of lighting fixtures at the front end of the vehicle because of the increasing underhood packaging density with emergence of new technologies and safety requirements. Moreover, there is a need to achieve alignment with minimal effort and manipulation by the customer.

Accordingly, the present invention provides a new and improved incandescent lamp including a self sealing mounting base design which overcomes difficulties with the prior art while providing more advantageous overall results.

### BRIEF DESCRIPTION OF THE INVENTION

An incandescent light source finds particular use in a lamp having a reflector is provided. The light source comprises an elongated envelope having a major axis and a filament secured therein such that a major axis of the filament is parallel or offset from the major axis of the envelope. A first fin is secured to the elongated envelope, which supports the envelope against vibrations. Other means of support for the light source of course could be used without departing from the scope of and intent of the subject invention. A base is also connected to the light source. The base includes a body, a flange extending radially from the body, a projection extending axially from the flange, and a twist lock construction capability that incorporates a reference plane perpendicular to the light source filament. To connect the base to the reflector, the projection is dimensioned to extend through an aperture of the reflector and the base is rotated to allow the twist lock to engaging the reflector thereby securing the replaceable bulb to the reflector.

An incandescent light source preferably comprises an envelope having a major axis and an elongated filament received in the envelope such that a major axis thereof is generally aligned with the major axis of the envelope. First and second rigid fins are electrically connected to and extend generally normal from the envelope for supporting the envelope against vibrations. Other means of support for the light source of course could be used without departing from the scope of and intent of the subject invention. A base is electrically connected and secured to the light source. A gasket is attached to the base for sealing the base to a reflector. The gasket has a sealing surface extending in a plane transverse to the major axes and is held in place by the radial flange on the base.

The light source includes an envelope formed from a light transmissive material and has a major axis. An axially extending filament is received in the envelope, a major axis of the filament being offset from the major axis of the envelope. A fin is secured to and extends generally normal from the envelope for supporting the envelope against vibrations. Other means of support for the light source of course could be used without departing from the scope of and intent of the subject invention. The fin electrically interconnects with the filament. A base is secured to the light source, the base including means for sealingly mounting the base to a reflector.

Still other aspects of the invention will become apparent from a reading and understanding of the detailed description of the several embodiments herein below.

### BRIEF DESCRIPTION OF THE DRAWINGS

FIG. 1 is an elevational view, in partial cross-section, of a portion of an incandescent light source of the present invention. Other means of support for the light source of course could be used without departing from the scope of and intent of the subject invention.

FIG. 2 is a side elevational view, in partial cross-section, of the incandescent light source of FIG. 1.

FIG. 3 is a side elevational view of a base according to a first embodiment of the incandescent light source of FIG. 1. Other shapes or types of base could be used without departing from the scope of and intent of the subject invention.

FIG. 4 is a bottom plan view of the base of FIG. 3.

FIG. 5 is a cross-sectional view of the base taken generally along line A-A of FIG. 4.

FIG. 6 is a cross-sectional view of the base taken generally along line B-B of FIG. 4.

FIG. 7 is a top plan view of the base of FIG. 3. Base twist lock is for reference only and would be design specific for this application.

FIG. 8 is a side elevational view of the base of FIG. 7.

FIG. 9 is a side elevational view of the base of FIG. 7.

FIG. 10 is a side elevational view of the base of FIG. 7.

FIG. 11 is a cross-sectional view of the base taken generally along line C-C of FIG. 7.

FIG. 12 is a front elevational view of a base according to a second embodiment of the incandescent light source of FIG. 1.

FIG. 13 is a side elevational view of the base of FIG. 12.

FIG. 14 is a top plan view of the base of FIG. 12.

FIG. 15 is a side elevational view of the base of FIG. 12.

FIG. 16 is a side elevational view of the base of FIG. 12.

FIG. 17 is a cross-sectional view of the base taken generally along line A-A of FIG. 12.

FIG. 18 is a cross-sectional view of the base taken generally along line B-B of FIG. 14.

### DETAILED DESCRIPTION OF THE PREFERRED EMBODIMENTS

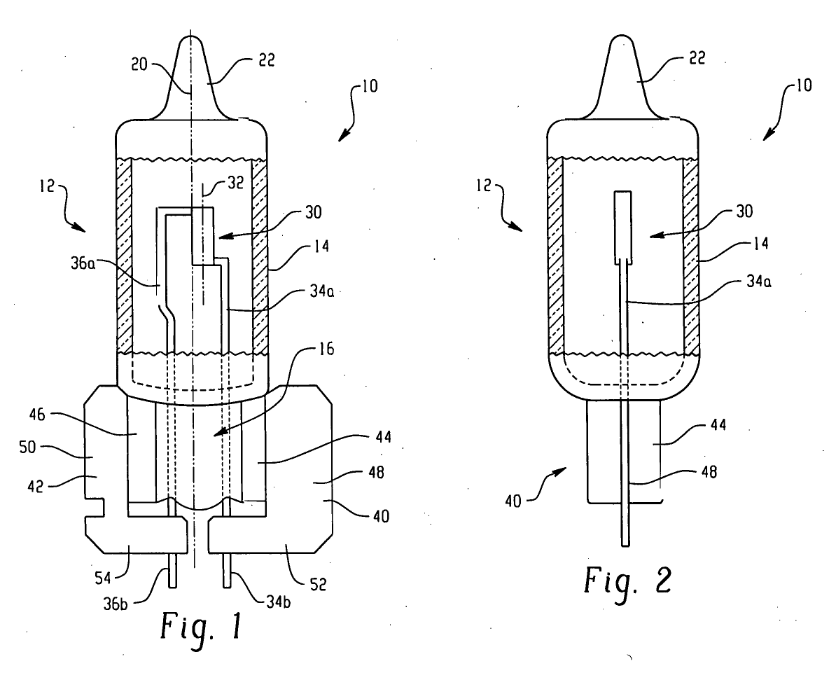

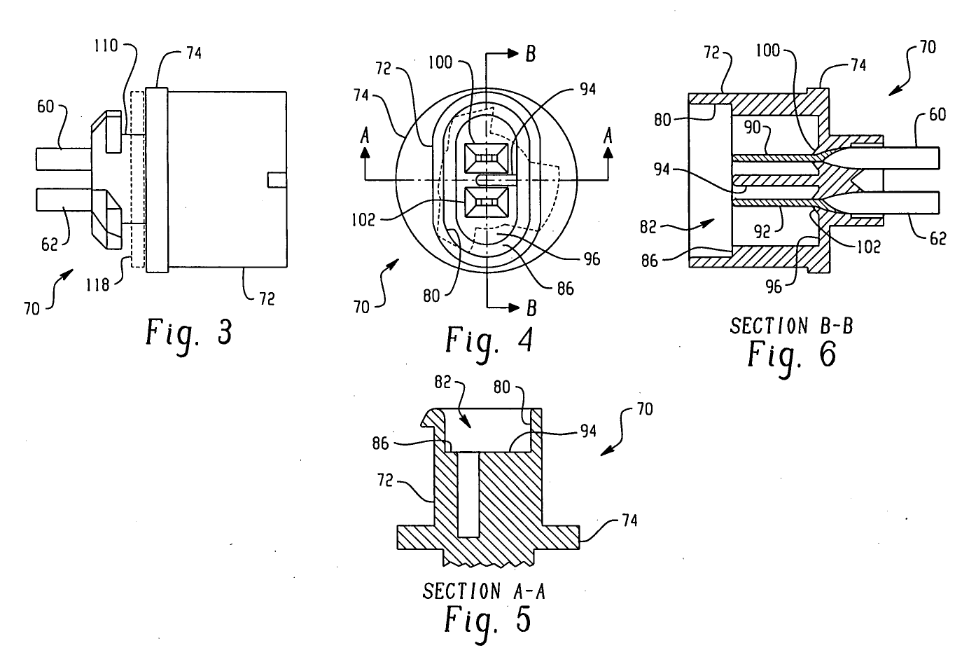

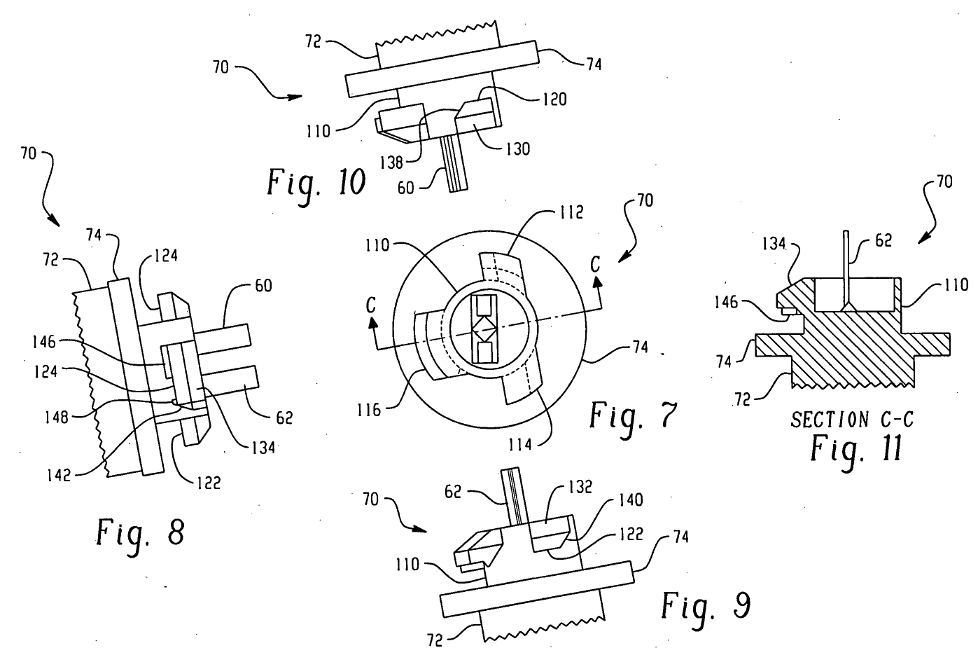

With reference to FIGS. 1 and 2, an incandescent light source 10 finding particular use in a fog lamp assembly (not shown) having a reflector (not shown) is illustrated. The incandescent light source has wattage between approximately twenty (20) watts and approximately sixty (60) watts. When used in the fog lamp assembly, the reflector receives light from the light source 10 and directs it through a lens to provide a predetermined beam pattern. The light source comprises an elongated pressurized envelope 12 formed from a vitreous or light transmissive material. In a preferred arrangement, the elongated envelope is formed of a quartz material. Of course, other light transmissive materials can be used without departing from the scope and intent of the subject invention.

The elongated envelope 12 includes a first portion 14 forming a sealed cavity and a second portion 16 or press seal base extending therefrom. The first portion 14 is generally cylindrical in cross-section and has a major axis 20. The second portion 16 is generally rectangular in cross-section; although, it should be appreciated that the second portion can have other conformations configured for receipt in a base to be described further below. An end 22 of the first portion 14 can be coated with a non-transmissive material to prevent stray light or glare as is well known in the art.

Contained within the elongated envelope 12 is a filament 30, usually of tungsten. The filament is secured for general alignment with the major axis 20 of the envelope. Specifically, the filament 30 extends axially within the envelope such that a major axis 32 of the filament is generally parallel or offset from the major axis of the envelope 12. Opposing ends of the filament 30 are mechanically secured and electrically connected to first and second lead inner wires 34a, 36a, respectively. The inner lead wires are preferably connected to thin metal foils (not shown), such as molybdenum foils, located in the second portion 16 of the envelope 12. More particularly, the molybdenum foils are mechanically and electrically connected to outer lead wires 34b, 36b that extend outwardly from the press seal base 16 of the lamp envelope.

When energized, the filament 30 emits radiation.

With continued reference to FIGS. 1 and 2, first and second fins 40, 42, respectively, are secured to the elongated envelope 12 to support the envelope against vibrations. Other means of support for the light source of course could be used without departing from the scope of and intent of the subject invention. The first and second fins are generally thin, planar components (compare FIGS. 1 and 2) and extend generally normal from opposing sides of the second portion 16 of the envelope. Each fin 40, 42 includes a first section 44, 46, respectively, mounted to the second portion 16 and a second section 48, 50, respectively, extending generally perpendicular therefrom. Each first section 44, 46 is generally “C” shaped to define a channel (not shown) dimensioned to receive an end of the second portion 16. Each second section 48, 50 is generally “L” shaped, as seen in FIG. 1, and a portion 52, 54 of each respective second section extends beneath the second portion 16 and is mechanically and electrically connected to the first and second lead wires 34, 36.

The first and second lead wires 34, 36 and the first and second fins 40, 42 are mechanically and electrically connected to respective first and second spaced apart leads 60, 62 (FIG. 3), in a well known manner. The leads are formed from an electrically conductive material to provide electrical current to the filament 30.

As shown in FIGS. 3, the leads 60, 62 extend through a base 70 and provide mechanical support to the light source 10. In this manner, the light source is fixed relative to the base 70, and an electrical connection can be easily established through the base with the leads 60, 62 which, in turn, provide current to the filament 30 through the first and second lead wires 34, 36 and the first and second fins 40, 42. Additionally, because the leads are slightly offset from a center axis of the base 70, the leads also provide a desired mounting orientation of light source 10.

With reference to FIGS. 3-6, the base 70, according to one embodiment of the present invention, includes a body 72 having a flange 74 extending radially therefrom. As shown in FIGS. 4 and 5, the body 72 is generally round and includes a wall 80 defining a cavity 82. A shelf 86 extends radially from an inner surface of wall 80 of the body. As shown in FIG. 6, electrically connected to the leads 60, 62 are a pair of electrical blades or contacts 90, 92 separated by a divider 94 extending axially from an end wall 96 of the body and radially spaced from the wall 80. The blades 90, 92 are mounted and supported in a pair of spaced apart frusto-pyramidal projections 100, 102 extending outwardly from the end wall 96. The blades are adapted to be electrically connected to a receptacle or an electrical source (not shown) in a manner well known in the art. Other shapes of bases used to mount the light source of course could be used without departing from the scope of and intent of the subject invention.

With reference again to FIG. 3, and with additional reference to FIG. 7, the base 70 further includes a hollow projection 110 extending axially from the flange 74. As shown in FIGS. 8-10, at least one lug extends radially outwardly from a surface of the projection adjacent an end portion of the projection. In this embodiment, the base 70 includes three circumferentially spaced lugs 112, 114, and 116 (FIG. 7), respectively. The base 70 also includes an annular gasket 118 (shown in dashed lines in FIG. 3) attached to the projection 110 and disposed between the flange 74 and the lugs for sealingly mounting the base to the reflector. The gasket has a sealing surface extending in a plane generally transverse to the major axis 20. Bottom surfaces 120, 122, 124 of each respective lug 112, 114, and 116 define a reference or fiducial plane for setting the focal point of the incandescent light source 10.

To assemble the incandescent light source 10, the first and second spaced apart leads 60, 62 are secured to the first and second fins 40, 42 in a well-known manner. Once secured, the major axis 32 of the filament 30 is coincident with a center axis of the projection 110. As such, the center axis of the projection is offset from the major axis 20 of the envelope 12.

To connect the base 70 to the reflector, the projection 110 including the lugs are advanced through a mounting aperture of the reflector such that the bottom surfaces of the lugs are adjacent an inner surface of the reflector. The aperture is dimensioned to allow the base projection to be inserted and rotated to lock into position so that the light source 10 is located at the focus of the reflector. For ease of insertion of the lugs 112, 114, 116 through the reflector aperture, each lug includes a chamfered surface 130, 132, 134. The base 70 is then rotated or twisted to sealingly secure the base to the reflector. Particularly, as the base is twisted, ramps 138, 140, 142 extending from the lugs engage the inner surface of the reflector. This, in turn, further advances the projection 110 relative to the reflector that presses the gasket 118 against an outer surface of the reflector thereby sealing the base to the reflector. The base is rotated until a stop 146 (FIGS. 8 and 11) extending from bottom surface 124 of lug 116 engages an edge of the reflector aperture and a lock 148, also located on bottom surface 124, extends through the reflector aperture.

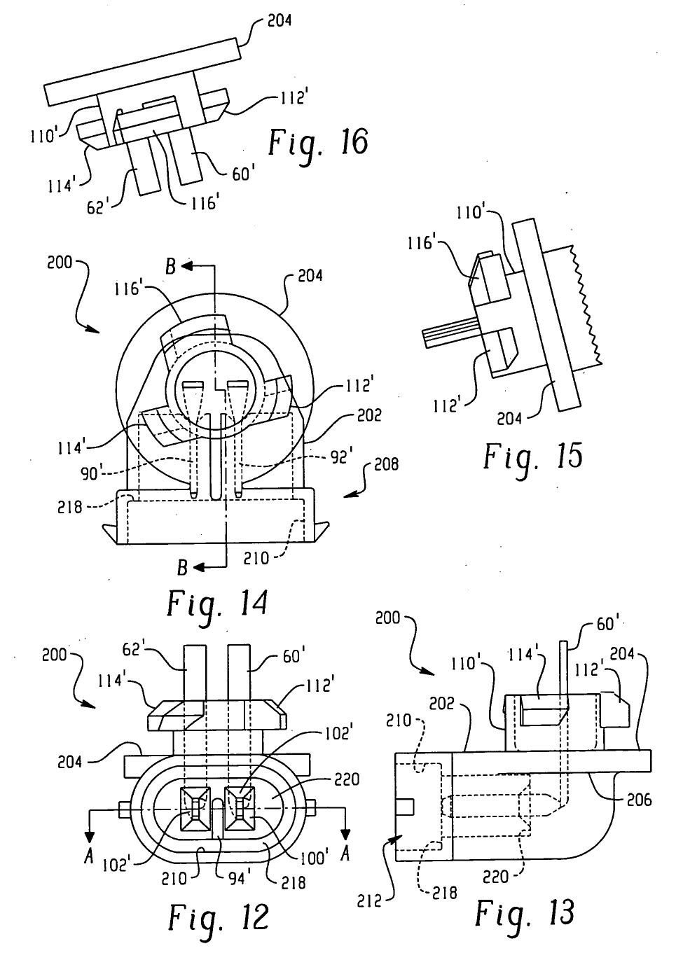

Similar to the aforementioned embodiment of the base 70, an additional embodiment of a base 200 is shown in FIGS. 12-18. Since most of the structure and function is substantially identical, reference numerals with a single primed suffix (′) refer to like components (e.g., projection 110 is referred to by reference numeral 110′), and new numerals identify new components in the additional embodiment. The primary distinctions relate to a body 202 of the base 200 which is generally normal to the projection 110′.

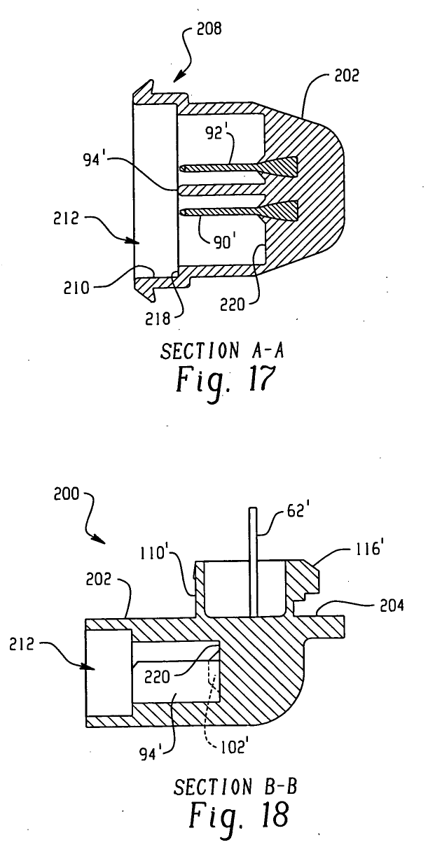

As shown in FIGS. 12-14, the base 200 includes the generally round body 202 and a flange 204 extending substantially perpendicularly from a first end portion 206 of the body. As shown in FIGS. 14 and 17, a second end portion 208 of the body extends outwardly from the body. The body 202 includes an inner wall 210 defining a cavity 212. A shelf 218 extends radially from the inner wall 210 of the body. As described above relative to the first embodiment, electrically connected to the leads 60′, 62′ are a pair of electrical blades or contacts 90′, 92′ separated by a divider 94′ extending outwardly from the inner wall 210 and an end wall 220 of the body and from. The blades are mounted and supported in a pair of spaced apart projections 100′, 102′ extending outwardly from the end wall 96′ (FIGS. 12 and 18).

The present disclosure has been described with reference to several embodiments. Obviously, modifications and alterations will occur to others upon reading and understanding the preceding detailed description. It is intended that the disclosure be construed as including all such modifications and alterations insofar as they come within the scope of the appended claims or the equivalents thereof.

What is claimed is:

1. An incandescent light source finding particular use in a lamp having an associated reflector, the light source comprising:
an elongated envelope having a major axis;
a filament secured therein such that a major axis of the filament is parallel or offset from the major axis of the envelope;
a base connected to the envelope:
the base includes a body, a flange extending radially from the body, a projection extending axially from the flange, and a twist lock construction, including a reference plane perpendicular to the light source filament, which reference plane sets the focal point of the incandescent light source.

2. The invention of claim 1 further comprising a first fin secured to the elongated envelope for supporting the envelope against vibration.

3. The invention of claim 2 further comprising a second fin secured to the elongated envelope, the first and second fins extending generally normal from opposing sides of the envelope.

4. The invention of claim 1 further comprising first and second lead wires electrically connected to opposing ends of the filament, the first and second lead wires being electrically connected to respective first and second spaced apart leads, the leads extending through the base and are adapted to be electrically connected to terminals of an associated electrical source.

5. The invention of claim 1 wherein first and second fins are electrically connected to one of the respective first and second lead wires and the respective first and second spaced apart leads.

6. The invention of claim 1 wherein the major axis of the filament is coincident with a center axis of the projection, the center axis being offset from the major axis of the envelope.

7. The invention of claim 1 further including a gasket attached to the projection and disposed between the flange and the lug, the gasket sealing the base to the associated reflector.

8. The invention of claim 1 wherein the incandescent light source has a wattage between approximately 20 watts and approximately 60 watts.

9. An incandescent light bulb comprising:
an envelope having a major axis;
an elongated filament received in the envelope such that a major axis thereof is generally aligned with the major axis of the light source;
first and second rigid fins electrically connected to and extending generally normal from the envelope for supporting the envelope against vibrations;
a base electrically connected and secured to the envelope; and
a gasket having a sealing surface extending in a plane transverse to the major axes and attached to the base for sealing the base to an associated reflector.

10. The invention of claim 9 wherein the base defines a center axis offset from the major axis of the envelope, the major axis of the filament being coincident with the base center axis.

11. The invention of claim 9 further comprising first and second lead wires electrically connected to opposing ends of the filament, the first and second lead wires being electrically connected to respective first and second spaced apart leads adapted to be electrically connected to terminals of an associated electrical source.

12. The invention of claim 11 wherein the first and second fins are electrically connected to one of the respective first and second lead wires and the respective first and second spaced apart leads.

13. The invention of claim 9 wherein the base includes:
a body;
two leads;
a flange extending radially from the body;
a projection extending axially from the flange; and
a twist lock construction capability that defines a fiducial plane for setting the focal point of the incandescent light source.

14. The invention of claim 13 wherein the projection is adapted to be secured to an associated reflector.

15. An incandescent lamp having an associated reflector comprising:
a light source including:
an envelope formed from a light transmissive material and having a major axis, and
an axially extending filament received in the envelope, a major axis of the filament being offset from the major axis of the envelope;
a fin secured to and extending generally normal from the envelope for supporting the envelope against vibrations and electrically interconnecting with the filament; and
a base secured to the light source, the base including means for sealingly mounting the base to an associated reflector.

16. The invention of claim 15 wherein the base includes a lug for securing the base to the associated reflector, the lug defining a reference plane for setting the focal point of the light source.

17. The invention of claim 15 wherein the base further includes a gasket disposed adjacent the lug for sealing the base to the associated reflector, a sealing surface of the gasket extending in a plane transverse to the major axis of the envelope.

18. The invention of claim 15 wherein the light source has wattage between approximately 20 watts and approximately 60 watts.
